(19) United States
(12) Patent Application Publication
(10) Pub. No.: US 2005/0157793 A1
(43) Pub. Date: Jul. 21, 2005

(54) Video coding/decoding method and apparatus

(75) Inventors: Ho-jin Ha, Seoul (KR); Woo-jin Han, Gyeonggi-do (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/034,734

(22) Filed: Jan. 14, 2005

(30) Foreign Application Priority Data
Jan. 15, 2004 (KR) 10-2004-0002976

(51) Int. Cl. H04N 7/12

(52) U.S. Cl. 375/240.16; 375/240.03; 375/240.18; 375/240.19; 375/240.12

(57) ABSTRACT

A video encoder/decoder and method. The video coding method includes estimating a virtual frame, electing a reference frame from candidate frames including the virtual frame to remove temporal redundancy using the elected reference frame, coding a motion vector and predetermined information obtained in removing the temporal redundancy, and obtaining transform coefficients from the frames free from the temporal redundancy and quantizing the obtained transform coefficients to generate a bit-stream. The video decoding method includes receiving a bit-stream and parsing the received bit-stream to extract information on coded frames, inversely quantizing the information on the coded frames to obtain the transform coefficients, and performing inverse spatial transform of the obtained transform coefficients and inverse temporal transform by use of a reference frame including a virtual frame in inverse order to an order in which redundancy of the coded frames is removed and restoring the coded frames. As a result, it is possible to code the video at a higher compression rate.

### CROSS-REFERENCE TO RELATED APPLICATION

This application claims priority from Korean Patent Application No. 10-2004-0002976 filed on Jan. 15, 2004 in the Korean Intellectual Property Office, the disclosure of which is incorporated herein by reference in its entirety.

### BACKGROUND OF THE INVENTION

1. Field of the Invention

The present invention relates to video compression, and more particularly to video coding/decoding in which, when a plurality of frames are compared to predict one of the frames, more similar frames are compared with more weights.

2. Description of the Related Art

With development of information and communication technologies including an Internet, there have been increasing various kinds of communications: character, voice as well as image. An existing character-based communication mode has fallen short of satisfying various demands of consumers. Hence there have been increasing multimedia services, which are available for various types of information, for example, on character, image, music and so on. Because of its enormous amount, multimedia data requires a large capacity of storage medium as well as a wide bandwidth for transmission. For example, a 24-bit true color image having a resolution of 640×480 requires a data capacity of 640×480×24 bits (7.37 Mbits) per frame. In order to transmit the 24-bit true color image at a rate of 30 frames per second, the bandwidth of 221 Mbps is required. For example, in order to store a movie running for 90 minutes, a storage space of about 1200 Gbits is required. Thus, in order to transmit such multimedia data including character, image and audio, it is essential to make use of a compression coding technique.

A basic principle of the data compression is a procedure of eliminating redundancy of the data. The data can be compressed by removal of spatial redundancy as in the case that the identical color or object is repeated within an image, of temporal redundancy as in the case that neighboring frames are hardly changed in a moving picture or that the same sound continues to be repeated in an audio, or psycho-visual redundancy taking into consideration that visual and perceptual capability of human beings is insensitive to high frequency.

The data compression can be divided into three types, lossy/lossless compression, intraframe/interframe compression and symmetric/asymmetric compression, depending on whether or not source data is lost, whether or not independent compression is done with respect to each frame, and whether or not times required for compression and restoration are equal. In addition, in the case where a delay time for compression or restoration does not exceed 50 ms, it is classified into real-time compression. In the case where there are various frame resolutions, it is classified into scalable compression. The lossless compression is used for character data, medical data and so on, while the lossy compression is mainly used for the multimedia data.

Meanwhile, the intraframe compression is used to remove spatial redundancy, while the interframe compression is used to remove temporal redundancy.

The transmission media for transmitting the multimedia information differ in performance according to the types of media. The transmission media in current use have a variety of transfer rates, for example, ranging from a very-high speed communication network capable of transmitting the data at the transfer rate of tens of Mbits per second to a mobile communication network having a transfer rate of 384 Kbps. The previous video coding such as MPEG-1, MPEG-2, H.263 or H.264 removes the redundancy based on a motion compensated prediction coding technique. Specifically the temporal redundancy is removed by motion compensation, while the spatial redundancy is removed by transform coding. These techniques have a good compression rate, but do not flexibility for a true scalable bit-stream due to use of a recursive approach in a main algorithm. Thus, recent researches have been actively made on wavelet-based scalable video coding.

FIG. 1 is a flow chart illustrating a conventional procedure for interframe wavelet video coding.

Images are received (S110). Here, the images are received in a unit of a group of pictures (GOP) consisting of a plurality of frames.

After the images are received, motion estimation is done (S120). The motion estimation makes use of a hierarchical variable size block matching (HVSBM) technique, which is as follows.

Referring to FIG. 2, in the case where an original image has a size of N*N, three images, level 0 (N*N), level 1 (N/2*N/2) and level 2 (N/4*N/4), are obtained by use of wavelet transform. Then, for the level 2 image, its block size for the motion estimation is changed into 16*16, 8*8 and 4*4, and each changed block is subjected to the motion estimation (ME) as well as evaluation of a magnitude of absolute distortion (hereinafter, referred to as MAD). Similarly, for the level 1 image, its block size for the motion estimation is changed into 32*32, 16*16, 8*8 and 4*4, and each changed block is subjected to the ME as well as evaluation of the MAD. Further, for the level 0 image, its block size for the motion estimation is changed into 64*64, 32*32, 16*16, 8*8 and 4*4, and each changed block is subjected to the ME as well as evaluation of the MAD.

Subsequently, in order to make the MAD minimal, routes along which the ME has been performed are pruned (S130). Using the ME having the optimal route, motion compensated temporal filtering (hereinafter, referred to as MCTF) is performed (S140).

Then, both spatial transform and quantization are performed (S150). A header is attached to data generated through the spatial transformation and quantization as well as ME data, so that a bit-stream is generated (S160).

In terms of the steps S120 and S140, the prior art has been designed to perform both forward and backward ME procedures on the basis of a current frame, to select one of the two ME procedures which provides a smaller MAD value, and to perform temporal filtering on the basis of the corresponding frame.

FIG. 3a shows a motion estimation direction between respective frame blocks in the prior art, and FIG. 3b is a flow chart illustrating a motion estimation procedure in the prior art.

When a plurality of frames are inputted for initial ME (S210), any one frame (a current frame) is subjected to a forward ME procedure with reference to a past frame preceding the current frame in time and its MAD value is calculated (S220). Further, the current frame is subjected to a backward ME procedure with reference to a future frame following the current frame in time and its MAD value is calculated (S230).

After the forward and backward ME procedures and the calculation of the MAD values, the MAD values are compared with each other, and then a smaller MAD value is selected (S240). A motion vector for the ME in the selected direction (either forward or backward) is found with respect to the corresponding block (S250). Finally, temporal filtering is performed through a result of performing the ME in the selected direction.

As set forth above, a scalable video codec may be generally divided into three procedures: temporal filtering, spatial transform and quantization of data parsed after the previous two procedures, all of which are performed to an inputted video stream. Of them, the temporal filtering procedure is important to find an optimal motion vector for the ME procedure in order to effectively remove the temporal redundancy of sequential frames.

However, when an object whose motion is rapidly changing is represented in the frames, the prior art has a limit to the ME for finding the optimal motion vector only with the past and future frames of the corresponding object. Thus, it has been proposed that it is necessary to find the optimal motion vector by performing the ME through additional election of the frames having a high degree of similarity to the current frame.

### SUMMARY OF THE INVENTION

To solve the above-indicated problems, one objective of the present invention is to provide a high compress rate in video coding by selecting a reference frame from candidate frames including a virtual frame to which a weight is applied.

In order to accomplish the objective, according to one exemplary embodiment of the present invention, there is provided a video encoder comprising: a temporal transform unit for receiving at least one video frame to make up at least one virtual frame and removing temporal redundancy of the received frames by means of comparison a current frame with candidate frames including the virtual frame; a spatial transform unit for removing spatial redundancy of the frames; a quantization unit for quantizing transform coefficients obtained by removal of the temporal and spatial redundancies; a motion vector encoding unit for coding a motion vector obtained from the temporal transform unit and predetermined information; and a bit-stream generation unit for generating a bit-stream using the quantized transform coefficients and the information coded by the motion vector encoding unit.

Preferably, the temporal transform unit removes the temporal redundancy of the received frames prior to the spatial transform unit, and the spatial transform unit removes the spatial redundancy of the frames from which the temporal redundancy has been removed to obtain the transform coefficients. Further, the spatial transform unit removes the spatial redundancy through wavelet transform.

More preferably, the temporal transform unit includes a weight calculation operation for calculating a weight representing a degree of similarity between a current frame in process of motion estimation and a frame spaced apart from the current frame in time, a motion estimation operation for electing a reference frame among candidate frames including the virtual frame estimated by application of the weight and comparing the current frame in process of the motion estimation with the reference frame to find the motion vector, and a temporal filtering operation for performing temporal filtering to the inputted frames using the motion vector.

Preferably, the candidate frames include a frame preceding the current frame in process of the motion estimation by one step in time, a frame following the current frame in process of the motion estimation by one step in time, and the virtual frame.

Preferably, the virtual frame is estimated by the following formula:

$$p {\sum }_{k} {S}_{n - 1} ( k ) + ( 1 - p ) {\sum }_{k} {S}_{n + 1} ( k )$$

where p is the weight, Sₙ₋₁ and Sₙ₊₁ are the frames preceding and following the current frame in process of the motion estimation by one step in time respectively, and k is the block which becomes a comparison target for the motion estimation of each frame.

Preferably, the weight is selected to minimize a difference E between the current frame in process of the motion estimation and the virtual frame, the difference E being expressed by the following equation:

$$E = \vert {\sum }_{k} {S}_{n} ( k ) - ( p {\sum }_{k} {S}_{n - 1} ( k ) + ( 1 - p ) {\sum }_{k} {S}_{n + 1} ( k ) ) \vert$$

More preferably, the weight p is calculated by the following equation:

$$p = \frac{{\sum }_{k} ( {S}_{n - 1} ( k ) - {S}_{n + 1} ( k ) ) ( {S}_{n} ( k ) - {S}_{n + 1} ( k ) )}{{\sum }_{k} {( {S}_{n - 1} ( k ) - {S}_{n + 1} ( k ) )}^{2}}$$

where Sₙ is the current frame in process of the motion estimation.

Preferably, the motion vector encoding unit additionally codes the weight for estimating the virtual frame when the virtual frame is selected as the reference frame.

Preferably, the bit-stream generation unit generates the bit-stream including information on the weight coded by the motion vector encoding unit.

In order to accomplish the objective, according to another embodiment of the present invention, there is provided a video coding method comprising: receiving a plurality of frames constituting a video sequence and estimating a virtual frame from the received frames; electing a reference frame from candidate frames including the virtual frame and removing temporal redundancy using the elected reference frame; coding a motion vector and predetermined information obtained in removing the temporal redundancy; and obtaining transform coefficients from the frames from which the temporal redundancy has been removed and quantizing the obtained transform coefficients to generate a bit-stream.

Preferably, in quantizing the transform coefficients to generate the bit-stream, the transform coefficients are obtained by spatial transform of the frames from which the temporal redundancy has been removed. Further, the spatial transform may be a wavelet transform.

Preferably, the operation of estimating the virtual frame makes use of a weight representing a degree of similarity between a current frame in process of motion estimation and a frame spaced apart from the current frame in time. Further, the candidate frames are comprised of a frame preceding the current frame in the process of motion estimation by one step in time, a frame following the current frame in process of the motion estimation by one step in time, and the virtual frame. Preferably, the reference frame is one of the candidate frames which has a minimal magnitude of absolute distortion as a result of the motion estimation of the current frame in process of the motion estimation and the candidate frames.

More preferably, the virtual frame is estimated by the following formula:

$$p {\sum }_{k} {S}_{n - 1} ( k ) + ( 1 - p ) {\sum }_{k} {S}_{n + 1} ( k )$$

where p is the weight, Sₙ−1 and Sₙ+1 are the frames preceding and following the current frame in process of the motion estimation by one step in time respectively, and k is the block which becomes a comparison target for the motion estimation of each frame.

Preferably, the weight is selected to minimize a difference E between the current frame in process of the motion estimation and the virtual frame, the difference E being expressed by the following equation:

$$E = \vert {\sum }_{k} {S}_{n} ( k ) - ( p {\sum }_{k} {S}_{n - 1} ( k ) + ( 1 - p ) {\sum }_{k} {S}_{n + 1} ( k ) ) \vert$$

More preferably, the weight p is calculated by the following equation:

$$p = \frac{{\sum }_{k} ( {S}_{n - 1} ( k ) - {S}_{n + 1} ( k ) ) ( {S}_{n} ( k ) - {S}_{n + 1} ( k ) )}{{\sum }_{k} {( {S}_{n - 1} ( k ) - {S}_{n + 1} ( k ) )}^{2}}$$

where Sₙ is the current frame in process of the motion estimation.

Preferably, the coded predetermined information includes the weight for estimating the virtual frame when the virtual frame is selected as the reference frame.

Preferably, the generated bit-stream includes information on the coded weight.

In order to accomplish the objective, according to yet another exemplary embodiment of the present invention, there is provided a video decoder comprising: a bit-stream parsing unit for parsing an inputted bit-stream to extract information on coded frames; an inverse quantization unit for inversely quantizing the information on the coded frames to obtain transform coefficients; an inverse spatial transform unit for performing inverse spatial transform; and an inverse temporal transform unit for performing inverse temporal transform using a reference frame including a virtual frame, wherein the frames are restored by performing the inverse spatial and temporal transforms of the transform coefficients in inverse order to an order of redundancy removal.

Preferably, the inverse spatial transform unit performs the inverse spatial transform prior to the inverse temporal transform unit, and the inverse temporal transform unit performs the inverse temporal transform to frames subjected to the inverse spatial transform. Further, the inverse spatial transform unit performs the inverse spatial transform in an inverse wavelet transform mode.

Preferably, the inverse temporal transform unit estimates the virtual frame using a weight which the bit-stream parsing unit parses the bit-stream to provide when a current frame in process of inverse temporal transform is temporally filtered in a coding procedure with the virtual frame set as the reference frame, and performs the inverse temporal transform with the virtual frame set as the reference frame.

Preferably, the virtual frame is estimated by the following formula:

$$p {\sum }_{k} {S}_{n - 1} ( k ) + ( 1 - p ) {\sum }_{k} {S}_{n + 1} ( k )$$

where p is the weight, Sₙ₋₁ and Sₙ₊₁ are the frames preceding and following the current frame in process of the inverse temporal transform by one step in time respectively, and k is the block which becomes a conversion target between the frames.

In order to accomplish the objective, according to still yet another exemplary embodiment of the present invention, there is provided a video decoding method comprising: receiving a bit-stream and parsing the received bit-stream to extract information on coded frames; inversely quantizing the information on the coded frames to obtain transform coefficients; and performing inverse spatial transform of the transform coefficients and inverse temporal transform by use of a reference frame including a virtual frame in inverse order to an order in which a redundancy of the coded frames is removed and restoring the coded frames.

Preferably, restoring the coded frames performs the inverse spatial transform to the transform coefficients, and performs the inverse temporal transform using the reference frame including the virtual frame. In this case, the inverse spatial transform may be a wavelet transform mode.

Preferably, performing the inverse temporal transform estimates the virtual frame using a weight which in the step of parsing the received bit-stream the bit-stream is parsed to provide when a current frame in process of the inverse temporal transform is temporally filtered in a coding procedure with the virtual frame set as the reference frame, and performs the inverse temporal transform with the virtual frame set as the reference frame.

Preferably, the virtual frame is estimated by the following formula:

$$p {\sum }_{k} {S}_{n - 1} ( k ) + ( 1 - p ) {\sum }_{k} {S}_{n + 1} ( k )$$

where p is the weight, Sₙ₋₁ and Sₙ₊₁ are the frames preceding and following the current frame in process of the inverse temporal transform by one step in time respectively, and k is the block which becomes a conversion target between the frames.

### BRIEF DESCRIPTION OF THE DRAWINGS

The above objectives, features and advantages will become more apparent from the following detailed description when taken in conjunction with the accompanying drawings, in which:

FIG. 1 is a flow chart illustrating a conventional procedure for interframe wavelet video coding;

FIG. 2 illustrates a hierarchical variable size block matching (HVSBM) technique for motion estimation;

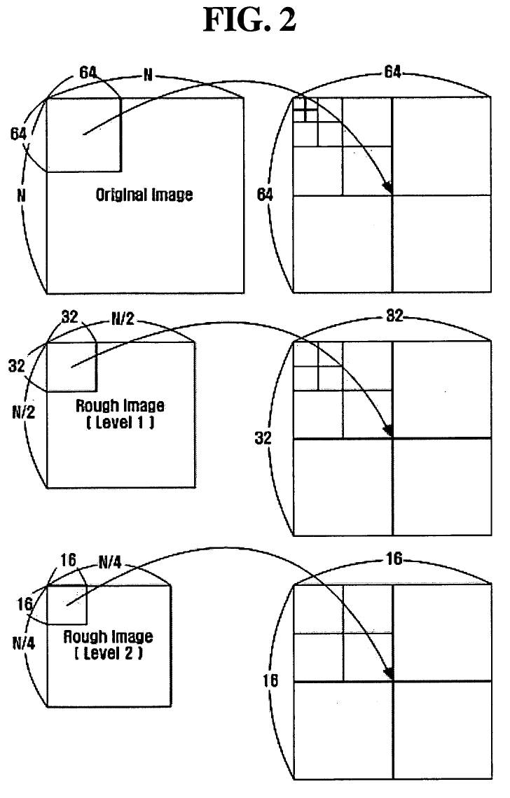

FIG. 3a shows a motion estimation direction between respective frame blocks in the prior art;

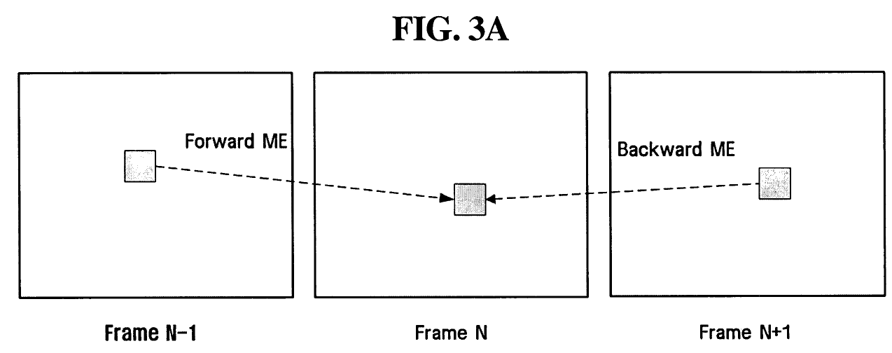

FIG. 3b is a flow chart illustrating a motion estimation procedure in the prior art;

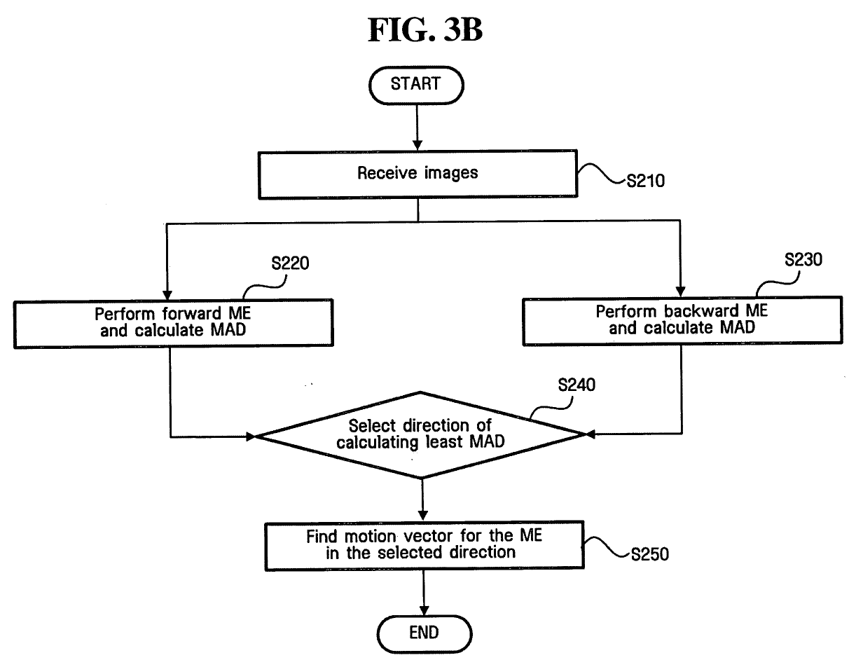

FIG. 4 is a block diagram illustrating a configuration of a video encoder according to one embodiment of the present invention;

FIG. 5 shows a procedure of performing motion estimation in a state where a virtual frame is included in candidate frames;

FIG. 6 is a block diagram illustrating a configuration of a video encoder according to another embodiment of the present invention;

FIG. 7 is a flow chart illustrating a video coding method according to one embodiment of the present invention;

FIG. 8 is a flow chart illustrating in more detail a procedure of finding a motion vector in accordance with one embodiment of the present invention;

FIG. 9 is a block diagram illustrating a video decoder according to one embodiment of the present invention; and

FIG. 10 is a flow chart illustrating a video decoding method according to one embodiment of the present invention.

### DETAILED DESCRIPTION OF THE PREFERRED EMBODIMENTS

Hereinafter, a detailed description will be made of a video coding/decoding method, a video encoder and a video decoder according to exemplary embodiments of the present invention with reference to the attached drawings.

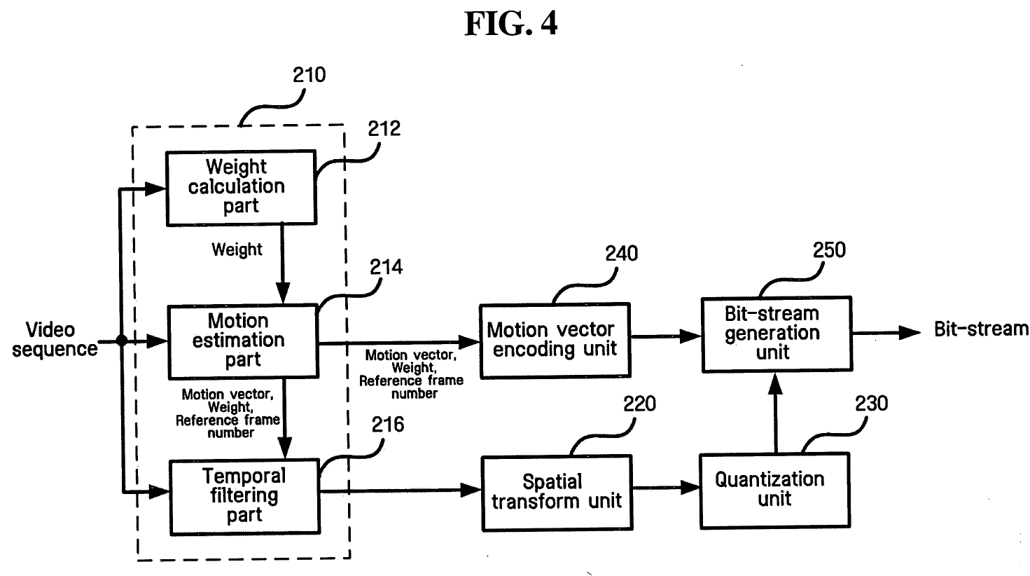

FIG. 4 is a block diagram illustrating a configuration of a video encoder according to one embodiment of the present invention.

The illustrated video encoder is comprised of a temporal transform unit 210 for removing temporal redundancy of a plurality of frames, a spatial transform unit 220 for removing spatial redundancy of the plurality of frames, a quantization unit 230 for quantizing transform coefficients generated by the removal of the temporal and spatial redundancies, a motion vector encoding unit 240 for encoding a motion vector, a predetermined weight and a reference frame number, and a bit-stream generation unit 250 for generating a bit-stream using the quantized transform coefficients as well as data and other information encoded by the motion vector encoding unit 240.

The temporal transform unit 210 includes a weight calculation part 212, a motion estimation part 214 and a temporal filtering part 216 in order to compensate a motion between the frames to perform temporal filtering.

The weight calculation part 212 calculates a weighted value (i.e., a weight) for estimating a virtual frame to which the weight is applied in order to find an optimal motion vector.

Hereinafter, a frame which becomes a criterion for the temporal filtering of inputted frames is referred to as a “reference frame.” As a degree of similarity of the reference frame to a current frame becomes higher in the process of temporal filtering, a compression rate of the reference frame becomes higher. Thus, in order to perform an optimal procedure of removing the temporal redundancy with respect to each of the inputted frames, the current frame in process of the temporal filtering is compared with the inputted frames, so any one of the inputted frames which has the optimal degree of similarity to the current frame is elected as the reference frame. Preferably, in this manner, the temporal redundancy of the inputted frames is removed (hereinafter, the frames for electing the reference frame are referred to as “candidate frames”).

As a general rule, two frames, one of which precedes the current frame by one step in time and the other follows it, have the highest possibility to represent the highest degree of similarity to the current frame. However, in the case of frames in which a rapidly moving object is included, even the two frames may have a considerable difference in the degree of similarity to the current frame. To prepare for this case, more appropriate candidate frames are required.

To this end, according to the degree of similarity to the current frame, the frame preceding the current frame in time (hereinafter, referred to as a “frame N−1”) and the frame following the current frame in time (hereinafter, referred to as a “frame N+1”) are each multiplied by a predetermined weight. A virtual weighted frame (hereinafter, referred to as a “virtual frame”), which may be estimated by summing up the frames N−1 and N+1 which are each multiplied by the weight, may be selected as the candidate frame. Here, the frames N−1 and N+1 may be ones which precede and follow the current frame by one step in time. The virtual frame may be expressed as follows:

$$p {\sum }_{k} {S}_{n - 1} ( k ) + ( 1 - p ) {\sum }_{k} {S}_{n + 1} ( k )$$

where, p is the weight, Sₙ−1 and Sₙ+1 are the frame N−1 and the frame N+1 respectively, and k is the block intended for the motion estimation at each frame.

The weight, p, for the virtual frame is preferably determined as a value that minimizes a difference, E, between the current frame and the virtual frame, wherein the difference, E, will be expressed by the following Equation 1.

$$E = \vert {\sum }_{k} {S}_{n} ( k ) - ( p {\sum }_{k} {S}_{n - 1} ( k ) + ( 1 - p ) {\sum }_{k} {S}_{n + 1} ( k ) ) \vert \qquad Equation 1$$

The weight, p, capable of meeting with a condition for minimizing a result of calculating Equation 1 may be calculated using the following Equation 2.

$$p = \frac{{\sum }_{k} ( {S}_{n - 1} ( k ) - {S}_{n + 1} ( k ) ) ( {S}_{n} ( k ) - {S}_{n + 1} ( k ) )}{{\sum }_{k} {( {S}_{n - 1} ( k ) - {S}_{n + 1} ( k ) )}^{2}} \qquad Equation 2$$

In this manner, according to the embodiment of the present invention, the weight must minimize a resulting of calculating Equation 1 and may be calculated by use of Equation 2.

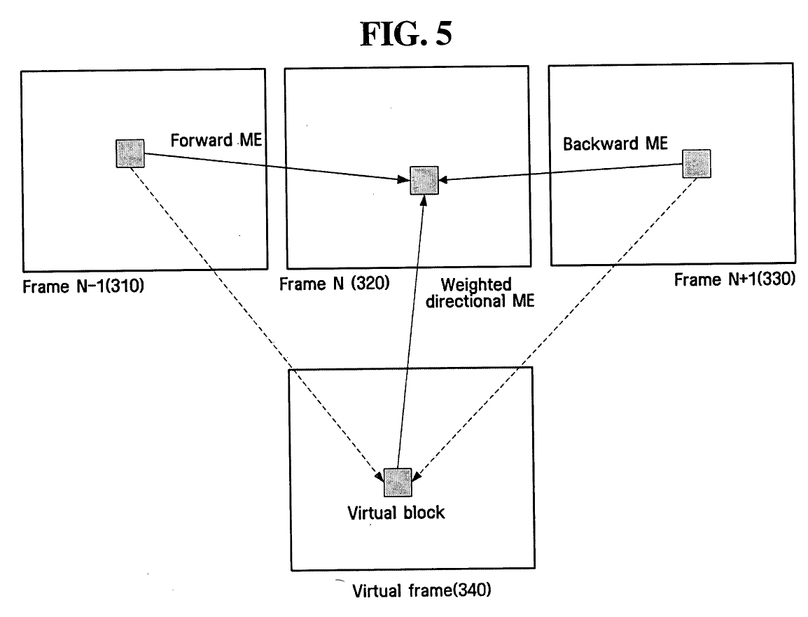

The motion estimation part 214 compares each current block of the current frame in the process of motion estimation with each candidate block of respective candidate frames which corresponds to each current block, thereby finding optimal motion vectors. In this case, the virtual frame may be also included in the candidate frame. Hereinafter, an operation of the motion estimation part 214 will be described with reference to FIG. 5.

FIG. 5 shows a procedure of performing motion estimation in a state where a virtual frame is included in candidate frames. The motion estimation part 214 is capable of generating a virtual frame 340 using a weight which is inputted from the weight calculation part 212. The virtual frame 340 is formed as the candidate frame, which becomes a target frame to be compared with a current frame 320 together with frames N−1 and N+1, frames 310 and 330. The motion estimation part 214 performs the motion estimation (ME) between the current frame 320 and the candidate frames 310, 330 and 340 (forward ME, backward ME and weighted directional ME). Then, the motion estimation part 214 finds motion vectors depending on a result of each ME, and calculates MAD values based on each directional ME. Here, in the case of the weighted directional ME, its target block is a virtual block constituting the virtual frame. Then, any one frame of the direction representing the minimum value among the calculated MAD values is selected as the reference frame, and the optimal motion vector is obtained from a result of performing the motion estimation of the each block.

The temporal filtering part 216 performs temporal filtering. For the purpose of performing this temporal filtering, the candidate frames whose motion vectors are found by the motion estimation part 214 are selected as the reference frames for removing the temporal redundancy with respect to the current frame, and information on the motion vectors of the elected reference frames is used. If the reference frame selected by the motion estimation part 214 is the virtual frame, the temporal filtering part 216 must receive the weight for calculating the virtual frame from the motion estimation part 214.

The frames from which the temporal redundancy is removed, namely, which are subjected to the temporal filtering, are again subjected to removal of the spatial redundancy through the spatial transform unit 220. The spatial transform unit 220 removes the spatial redundancy from the temporally filtered frames using spatial transform, and in the case of a preferred embodiment of the present embodiment, using a wavelet transform.

The currently known wavelet transform divides one frame into quarters, replaces one quadrant of the frame with a scaled-down image (L-image) which has a quarter area of the frame and is almost similar to the entire image and simultaneously the other three quadrants with information (H-image) which allows the entire image to be restored through the L-image. In a similar manner, the L-frame may be replaced with an LL-image having a quarter area of the L-frame and information for restoring the L-image. The image compression technique using this wavelet transform is applied to a JPEG2000 compression technique. The wavelet transform allows the spatial redundancy to be removed from the frames. In the wavelet transform, original image information is stored in a transformed image in a scaled-down form unlike a discrete cosine transform (DCT), so that the wavelet transform makes it possible to perform video coding having spatial scalability using the scaled-down image. Herein the wavelet transform technique is simply one example. For example, if it is not necessary to accomplish the spatial scalability, it is possible to make use of the DCT technique which is widely used for an existing moving picture compression technique such as MPEG-2.

The temporally filtered frames are changed into transform coefficients through the spatial transform, and then the transform coefficients are transmitted to the quantization unit 230 and quantized there. The quantization unit 230 quantizes the transform coefficients, real number-type coefficients, to change them into integer-type transform coefficients. In other words, the amount of bits for expressing image data can be reduced through the quantization. Herein the quantization of the transform coefficients is performed through an embedded quantization technique.

In this manner, by performing the quantization of the transform coefficients through an embedded quantization technique, it is possible not only to decrease the amount of required information but also to get SNR scalability. The term “embedded” is used to mean that a coded bit-stream includes quantization. To put it in another way, compressed data are generated in order of visual importance, or are tagged by visual importance. A level of actual quantization (or visual importance) may function at either a decoder or a transmission channel.

If all resources such as transmission bandwidth, storage capability and display are accepted, any image can be restored without a loss. However, if not so, the image is quantized so much as is required by the most restricted resource. Currently, there are known various embedded quantization algorithms such as EZW (Embedded Zerotree Wavelet), SPIHT (Set Partitioning in Hierarchial Trees), EZBC (Embedded Zerotree Block Coding), EBCOT (Embedded Block Coding with Optimized Truncation) etc., and any one of these known algorithms may be used in the present embodiment.

The motion vector encoding unit 240 encodes the weights, the motion vectors and the numbers of the reference frames whose motion vectors are found, which are inputted by the motion estimation part 214, and outputs them to the bit-stream generation unit 250.

The bit-stream generation unit 250 attaches a header to data including the coded image information, the coded information of the weights, the motion vectors and the reference frame numbers and so on, thereby generating a bit-stream.

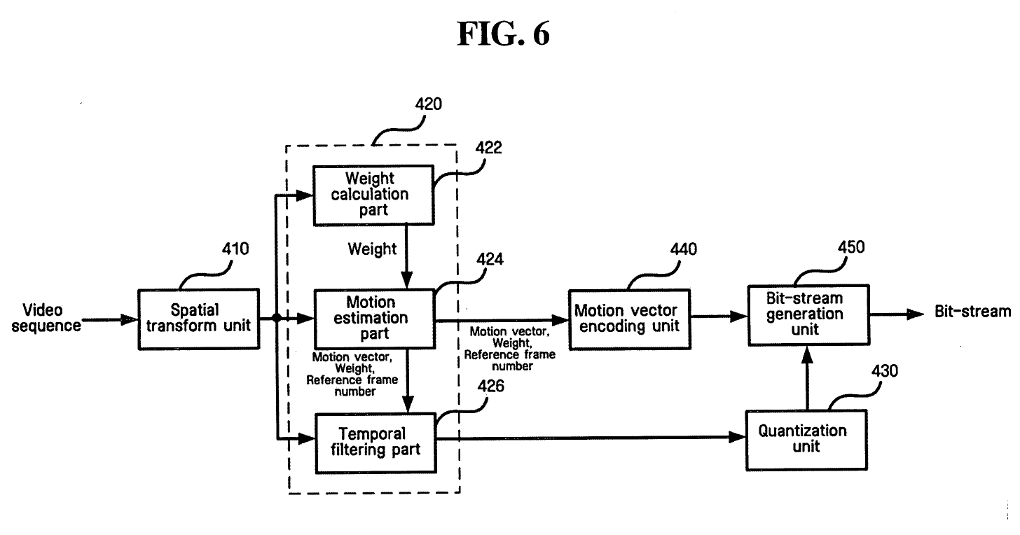

Meanwhile, in the case of using the wavelet transform when the spatial redundancy is removed, a form of the original image remains in the transformed frame. Thus, unlike a DCT-based moving picture coding technique, after the spatial transform and then the temporal transform, the transformed frame is quantized, so that the bit-stream can be generated. With regard to this, another embodiment will be described with reference to FIG. 6.

FIG. 6 is a block diagram illustrating a configuration of a video encoder according to another embodiment of the present invention.

The video encoder according to the present embodiment is comprised of a spatial transform unit 410 for removing spatial redundancy of a plurality of frames constituting a video sequence, a temporal transform unit 420 for removing temporal redundancy of the plurality of frames, a quantization unit 430 for quantizing transform coefficients obtained by the removal of the temporal and spatial redundancies, a motion vector encoding unit 440 for encoding a motion vector, a predetermined weight and a reference frame number, and a bit-stream generation unit 450 for generating a bit-stream using the quantized transform coefficients as well as data and other information encoded by the encoding unit 440.

With regard to the transform coefficient, conventionally, a technique of performing the spatial transform after the temporal filtering has been mainly used in the moving picture compression. Hence, the term “transform coefficient” stands for a value generated by the spatial transform for the most part. In other words, the transform coefficient has been used as a DCT coefficient when it is generated by the DCT, or as a wavelet coefficient when it is generated by the wavelet transform. In the present embodiment, the transform coefficient is a value generated by removing the spatial and temporal redundancies from the frames, which refers to a value before the quantization (embedded quantization) is performed.

It should be noted that, in the embodiment of FIG. 4, the transform coefficient, as in the prior art, refers to one generated through the spatial transform, while in the embodiment of FIG. 6, it may refer to one generated through the temporal transform.

The spatial transform unit 410 removes the spatial redundancy of the plurality of frames constituting the video sequence. In this case, the spatial transform unit removes the spatial redundancy of the frames using the wavelet transform. The frames from which the spatial redundancy is removed, i.e., the spatially transformed frames are transmitted to the temporal transform unit 420.

The temporal transform unit 420 removes the temporal redundancy from the spatially transformed frames. To this end, the temporal transform unit 420 includes a weight calculation part 422, a motion estimation part 424 and a temporal filtering part 426. In the present embodiment, the temporal transform unit 420 is operated in the same fashion as that of the embodiment of FIG. 4, but it is different from that of the embodiment of FIG. 4 in that it receives the spatially transformed frames. Further, the temporal transform unit 420 may be different from that of the embodiment of FIG. 4 in that it generates the transform coefficients for the quantization after removing the temporal redundancy from the spatially transformed frames.

The quantization unit 430 quantizes the transform coefficients to make quantized image information (coded image information), and provides the information to the bit-stream generation unit 450. The quantization is the embedded quantization as in the embodiment of FIG. 4, and is allowed to obtain SNR scalability for a bit-stream to be finally generated.

The motion vector encoding unit 440 encodes a motion vector and a number of the reference frame whose motion vector is found, which are inputted by the motion estimation part 424. Here, when a reference frame for an arbitrary frame is a virtual frame, a weight capable of estimating the virtual frame must be encoded as well.

The bit-stream generation unit 450 includes the coded image information, the motion vector information and so on, and attaches a header to generate the bit-stream.

Meanwhile, the bit-stream generation unit 450 of FIG. 6 may include information on the order in which the temporal and spatial redundancies are removed (hereinafter, referred to as an “order of redundancy removal”) in the bit-stream so as to have knowledge of whether or not the video sequence is coded according to the embodiment of FIG. 6 on a decoding side. This is also true of the bit-stream generation unit 250 of FIG. 4.

In order to include the order of redundancy removal in the bit-stream, various schemes may be used. In this case, of the various schemes, one is determined as a basic scheme and the others can be separately represented in the bit-stream. For example, if the scheme of FIG. 4 is the basic scheme, information on the order of redundancy removal can be represented only in the bit-stream generated from the scalable video encoder of FIG. 6, but not in the bit-stream generated from the scalable video encoder of FIG. 4. Alternatively, the information on the order of redundancy removal may be represented in both cases based on the schemes of FIGS. 4 and 6.

By realizing a video encoder having all functions of the video encoders according to the embodiments of FIGS. 4 and 6, and coding and comparing the video sequences by use of the schemes of FIGS. 4 and 6, it is possible to generate the bit-stream caused by the coding having good efficiency. In this case, the order of redundancy removal must be included in the bit-stream. Here, the order of redundancy removal may be determined either in a video sequence unit or in a GOP (Group of Pictures) unit. In the former case, the order of redundancy removal is preferably included in a header of the video sequence. In the latter case, the order of redundancy removal is preferably included in a header of the GOP.

It should be noted that the embodiments of FIGS. 4 and 6 may be all realized by hardware, but they may be also realized by software modules and apparatuses having computing capability capable of executing the modules.

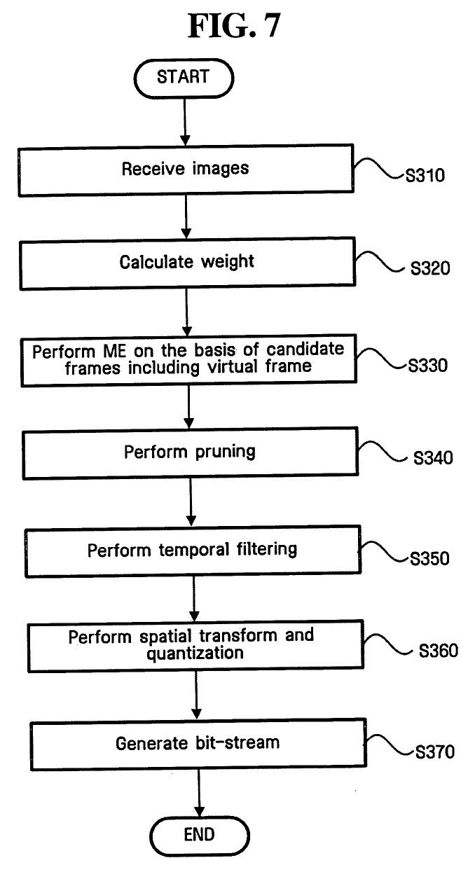

FIG. 7 is a flow chart illustrating a video coding method according to one embodiment of the present invention.

Images are received (S310). Here, the images are received in the GOP unit consisting of a plurality of frames. Preferably, each GOP consists of 2ⁿ frames (where n is the natural number) for the sake of calculation and treatment convenience. That is, it may include 2, 4, 8, 16, 32 and so on. As the number of the frames constituting one GOP increases, there is a characteristic that video coding increases in efficiency but buffering and coding increase in time. By contrast, as the number of the frames decreases, there is a characteristic that the video coding decreases in efficiency.

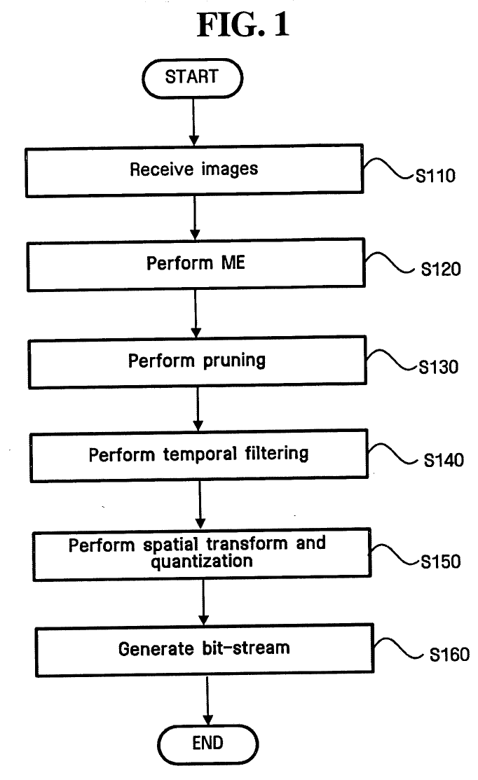

When receiving the images, the weight calculation part 212 (FIG. 4) calculates a predetermined weight which satisfies Equations 1 and 2 (S320). The calculated weight is used to estimate a virtual frame at the motion estimation part 214. The estimated virtual frame is subjected to motion estimation by means of comparison with a current frame, together with frames N−1 and N+1 (S330). Preferably, basic motion estimation makes use of the HVSBM (Hierarchical Variable Size Block Matching) like the conventional motion estimation technique described with reference to FIG. 1.

As a result of the motion estimation, a frame representing the least MAD is selected as a reference frame, and then the pruning procedure as in the prior art is performed (S340). With use of selected motion vectors, the temporal filtering part 216 removes the temporal redundancy (S350).

The frames from which the temporal redundancy is removed are subjected to spatial transform and quantization by means of the spatial transform unit 220 and the quantization unit 230 (S360). Finally, the bit-stream generation unit 250 generates a bit-stream, which adds predetermined information to the data generated by the spatial transform and quantization as well as to the data of the motion vectors, the weights, and the reference frame numbers, all of which are coded by the encoding unit 240 (S370).

Among the procedures, the spatial transform procedure may precede the procedure S320 of calculating the weight. In this case, the spatial transform must be the wavelet transform.

Therefore, the procedure S370 of generating the bit-stream may additionally generate information on which of the procedures S320 and S350 of performing the spatial and temporal transforms precedes the other.

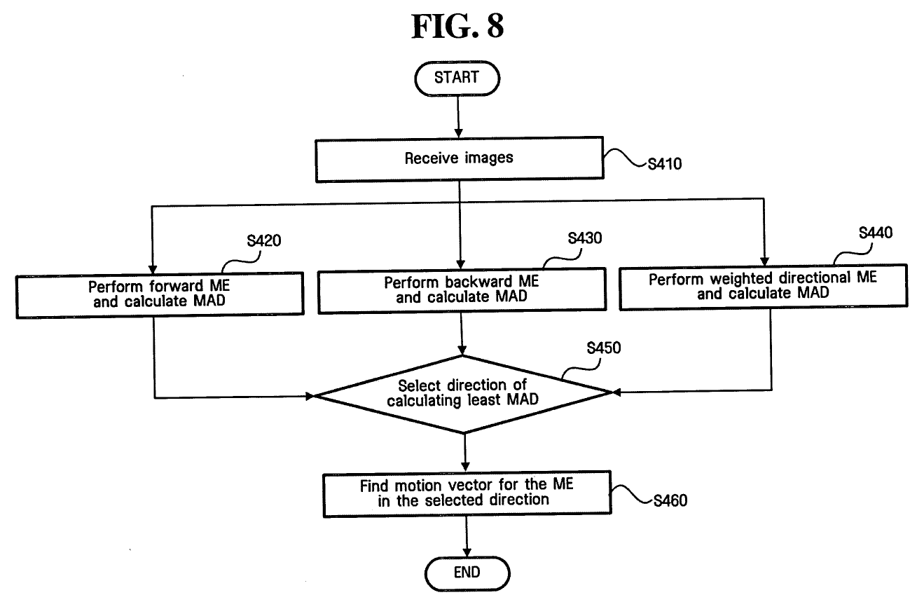

FIG. 8 is a flow chart illustrating in more detail a procedure of finding a motion vector in accordance with one embodiment of the present invention.

When a frame for initial motion estimation is inputted (S410), the corresponding frame is subjected to forward and backward motion estimation procedures, and thereby motion vectors and MAD values of each direction are found (S420 and S430). Further, frames N−1 and N+1 are each multiplied by a predetermined weight calculated by the weight calculation part 212, and the motion estimation of a current frame are preformed with reference to a virtual frame which can be estimated by the sum of each multiplied result, and thereby a motion vector and an MAD value are found (S440).

The virtual frame may be estimated by the following formula:

$$p {\sum }_{k} {S}_{n - 1} ( k ) + ( 1 - p ) {\sum }_{k} {S}_{n + 1} ( k )$$

The description of this formula is as above-mentioned.

By comparing the three calculated MAD values, a direction in which the least MAD value is calculated is selected (S450). The frame for which the selected MAD value is calculated is elected as the reference frame, and a motion vector generated from a result of the motion estimation with the corresponding frame is obtained (S460).

With use of the motion vector obtained by the above-mentioned procedure, the temporal filtering part 216 removes the temporal redundancy from the current frame. Here, in the case where the reference frame is the virtual frame, the weight is also transmitted to the temporal filtering part 216 so that the virtual frame can be estimated.

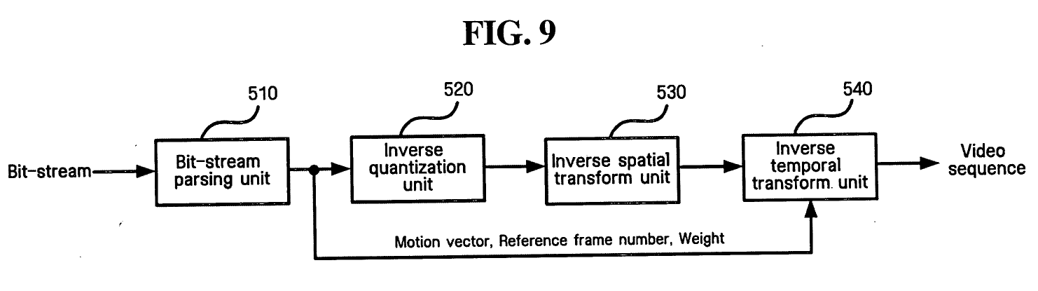

FIG. 9 is a block diagram illustrating a video decoder according to one embodiment of the present invention. The illustrated video decoder includes a bit-stream parsing unit 510, an inverse quantization unit 520, an inverse spatial transform unit 530 and an inverse temporal transform unit 540.

The bit-stream parsing unit 510 parses an inputted bit-stream to extract a motion vector and a reference frame number for restoring coded image information (coded frames) and each image information, and extracts a weight transmitted when the corresponding image information is temporally filtered with a virtual frame set as a reference frame.

The extracted image information is inversely quantized by the inverse quantization unit 520 and is converted into transform coefficients. The transform coefficients are subjected to inverse spatial transform by means of the inverse spatial transform unit 530. The inverse spatial transform is associated with spatial transform of the coded frames. Specifically, in the case where the spatial transform is the wavelet transform, the inverse spatial transform is inverse wavelet transform. Further, in the case where the spatial transform is the DCT, the inverse spatial transform is an inverse DCT.

The transform coefficients are converted into temporally filtered frames after the inverse spatial transform. The temporally filtered frames are subjected to inverse temporal transform by means of the inverse temporal transform unit 540. Here for the purpose of performing the inverse temporal transform, information on the motion vector and the reference frame number obtained by the bit-stream parsing is used. If a frame in the process of inverse temporal transform is temporally filtered in a coding procedure with the virtual frame set as the reference frame, a weight for estimating the virtual frame is additionally obtained by the bit-stream parsing. The virtual frame as the reference frame for the inverse temporal transform of the present frame can be estimated by calculation of the following formula.

$$p {\sum }_{k} {S}_{n - 1} ( k ) + ( 1 - p ) {\sum }_{k} {S}_{n + 1} ( k )$$

Details of the formula are as above-mentioned.

The illustrated decoder in FIG. 9 may be constructed so that the inverse temporal transform unit may be disposed in the front of the inverse spatial transform unit. In addition, the illustrated decoder and a modified decoder where the inverse temporal transform unit is disposed in the front of the inverse spatial transform unit may be incorporated into one decoder. Thus, predetermined information capable of knowing which of the inverse temporal and spatial transforms is performed first may be analyzed during the bit-stream parsing.

Further, the decoder may be realized either by hardware or by software modules.

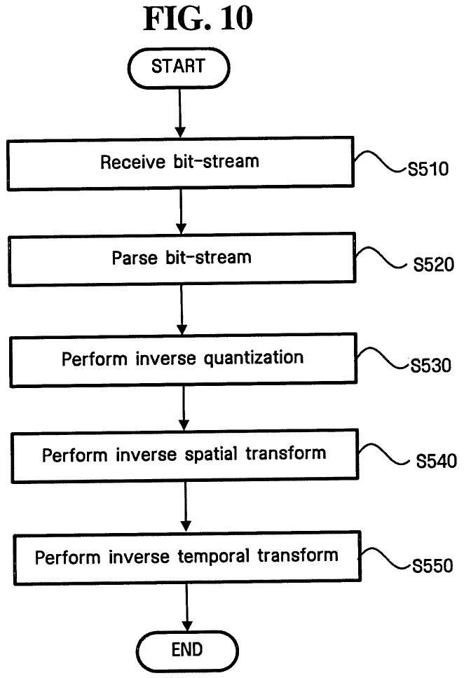

FIG. 10 is a flow chart illustrating a video decoding method according to another embodiment of the present invention.

When an initial bit-stream is inputted (S510), the bit-stream parsing unit 510 parses the inputted bit-stream to extract image information and information on a motion vector, a reference frame number and a weight (S520).

The extracted information is inversely quantized by the inverse quantization unit 520 and is converted into transform coefficients (S530). The transform coefficients obtained by the inverse quantization are subjected to inverse spatial transform by means of the inverse spatial transform unit 530 (S540). The inverse spatial transform is associated with spatial transform of the coded frames. Specifically, in the case where the spatial transform is the wavelet transform, the inverse spatial transform is inverse wavelet transform. Further, in the case where the spatial transform is the DCT, the inverse spatial transform is an inverse DCT.

The transform coefficients are converted into temporally filtered frames after the inverse spatial transform. The temporally filtered frames are subjected to inverse temporal transform by means of the inverse temporal transform unit 540 (S550) and are outputted as a video sequence. Here for the purpose of performing the inverse temporal transform, information on the motion vector and the reference frame number obtained by the bit-stream parsing is used. If a frame in process of the inverse temporal transform is temporally filtered in a coding procedure with the virtual frame set as the reference frame, a weight for estimating the virtual frame is additionally obtained by the bit-stream parsing. The virtual frame as the reference frame for the inverse temporal transform of the present frame can be estimated by calculation of the following formula.

$$p {\sum }_{k} {S}_{n - 1} ( k ) + ( 1 - p ) {\sum }_{k} {S}_{n + 1} ( k )$$

Details of the formula are as above-mentioned.

Among the above-mentioned procedures, the procedure S550 of performing the inverse temporal transform may precede the procedure S540 of performing the inverse spatial transform. In this case, the inverse spatial transform becomes the wavelet transform.

While the present invention has been described in detail in connection with certain embodiments thereof, the embodiments are simply illustrative. It will be understood by those skilled in the art that the present invention may be implemented in a different specific form without changing the technical spirit or essential characteristics thereof. Therefore, it should be understood that simple modifications according to the embodiments of the present invention may belong to the technical spirit of the present invention.

As set forth above, when a plurality of frames are compared in order to predict one frame, a weight is placed on a more similar frame. A virtual frame to which the weight is applied is compared, so that a higher compression rate can be provided in the video coding.

1. A video encoder comprising:
a temporal transform unit for receiving at least one video frame to make up at least one virtual frame and removing temporal redundancy of the received frame by comparing a current frame with candidate frames including the virtual frame;
a spatial transform unit for removing spatial redundancy of the frame;
a quantization unit for quantizing transform coefficients obtained by removal of the temporal and spatial redundancies;
a motion vector encoding unit for coding a motion vector obtained from the temporal transform unit and predetermined information; and
a bit-stream generation unit for generating a bit-stream using the quantized transform coefficients and the information coded by the motion vector encoding unit.

2. The video encoder as claimed in claim 1, wherein the temporal transform unit removes the temporal redundancy of the received frame prior to the spatial transform unit, and the spatial transform unit removes the spatial redundancy of the frame from which the temporal redundancy has been removed to obtain the transform coefficients.

3. The video encoder as claimed in claim 1, wherein the spatial transform unit removes the spatial redundancy through wavelet transform.

4. The video encoder as claimed in claim 1, wherein the temporal transform unit includes:
a weight calculation part for calculating a weight representing a degree of similarity between a current frame in process of motion estimation and a frame spaced apart from the current frame in time;
a motion estimation part for electing a reference frame from candidate frames including the virtual frame estimated by application of the weight and comparing the current frame in process of motion estimation with the reference frame to find the motion vector; and
a temporal filtering part for performing temporal filtering to the inputted frames using the motion vector.

5. The video encoder as claimed in claim 4, wherein the candidate frames include a frame preceding the current frame in process of motion estimation by one step in time, a frame following the current frame in process of motion estimation by one step in time, and the virtual frame.

6. The video encoder as claimed in claim 5, wherein the reference frame is one of the candidate frames which has a minimal magnitude of absolute distortion as a result of the motion estimation of the current frame in process of the motion estimation and the candidate frames.

7. The video encoder as claimed in claim 6, wherein the virtual frame is estimated by the following formula:
$$p {\sum }_{k} {S}_{n - 1} ( k ) + ( 1 - p ) {\sum }_{k} {S}_{n + 1} ( k )$$
where p is the weight, Sₙ₋₁ and Sₙ₊₁ are the frames preceding and following the current frame in process of motion estimation by one step in time respectively, and k is the block which becomes a comparison target for the motion estimation of each frame.

8. The video encoder as claimed in claim 7, wherein the weight is selected to minimize a difference E between the current frame in process of motion estimation and the virtual frame, the difference E being expressed by the following equation:
$$E = \vert {\sum }_{k} {S}_{n} ( k ) - ( p {\sum }_{k} {S}_{n - 1} ( k ) + ( 1 - p ) {\sum }_{k} {S}_{n + 1} ( k ) ) \vert$$

9. The video encoder as claimed in claim 8, wherein the weight p is calculated by the following equation:
$$p = \frac{{\sum }_{k} ( {S}_{n - 1} ( k ) - {S}_{n + 1} ( k ) ) ( {S}_{n} ( k ) - {S}_{n + 1} ( k ) )}{{\sum }_{k} {( {S}_{n - 1} ( k ) - {S}_{n + 1} ( k ) )}^{2}}$$
where Sₙ is the current frame in process of the motion estimation.

10. The video encoder as claimed in claim 9, wherein the motion vector encoding unit additionally codes the weight for estimating the virtual frame when the virtual frame is selected as the reference frame.

11. The video encoder as claimed in claim 10, wherein the bit-stream generation unit generates the bit-stream including information on the weight coded by the motion vector encoding unit.

12. A video coding method comprising:
receiving a plurality of frames constituting a video sequence and estimating a virtual frame from the received frames;
electing a reference frame from candidate frames including the virtual frame and removing temporal redundancy using the elected reference frame;
coding a motion vector and predetermined information obtained in removing the temporal redundancy; and
obtaining transform coefficients from the frames from which the temporal redundancy has been removed and quantizing the obtained transform coefficients to generate a bit-stream.

13. The video coding method as claimed in claim 12, wherein in quantizing the transform coefficients to generate the bit-stream, the transform coefficients are obtained by spatial transform of the frames from which the temporal redundancy has been removed.

14. The video coding method as claimed in claim 13, wherein the spatial transform is wavelet transform.

15. The video coding method as claimed in claim 12, wherein estimating the virtual frame uses of a weight representing a degree of similarity between a current frame in process of motion estimation and a frame spaced apart from the current frame in time

16. The video coding method as claimed in claim 15, wherein the candidate frames include a frame preceding the current frame in process of motion estimation by one step in time, a frame following the current frame in process of motion estimation by one step in time, and the virtual frame.

17. The video coding method as claimed in claim 16, wherein the reference frame is one of the candidate frames which has a minimal magnitude of absolute distortion as a result of the motion estimation of the current frame in process of motion estimation and the candidate frames.

18. The video coding method as claimed in claim 17, wherein the virtual frame is estimated by the following formula:
$$p {\sum }_{k} {S}_{n - 1} ( k ) + ( 1 - p ) {\sum }_{k} {S}_{n + 1} ( k )$$
where p is the weight, Sₙ₋₁ and Sₙ₊₁ are the frames preceding and following the current frame in process of motion estimation by one step in time respectively, and k is the block which becomes a comparison target for motion estimation of each frame.

19. The video coding method as claimed in claim 18, wherein the weight is selected to minimize a difference E between the current frame in process of motion estimation and the virtual frame, the difference E being expressed by the following equation:
$$E = \vert {\sum }_{k} {S}_{n} ( k ) - ( p {\sum }_{k} {S}_{n - 1} ( k ) + ( 1 - p ) {\sum }_{k} {S}_{n + 1} ( k ) ) \vert$$

20. The video coding method as claimed in claim 19, wherein the weight p is calculated by the following equation:
$$p = \frac{{\sum }_{k} ( {S}_{n - 1} ( k ) - {S}_{n + 1} ( k ) ) ( {S}_{n} ( k ) - {S}_{n + 1} ( k ) )}{{\sum }_{k} {( {S}_{n - 1} ( k ) - {S}_{n + 1} ( k ) )}^{2}}$$
where Sₙ is the current frame in process of the motion estimation.

21. The video coding method as claimed in claim 20, wherein the coded predetermined information includes the weight for estimating the virtual frame when the virtual frame is selected as the reference frame.

22. The video coding method as claimed in claim 21, wherein the generated bit-stream includes information on the coded weight.

23. A recording medium for recording programs capable of being read by a computer for executing the video coding method claimed in claim 12.

24. A video decoder comprising:
a bit-stream parsing unit for parsing an inputted bit-stream to extract information on coded frames;
an inverse quantization unit for inversely quantizing the information on the coded frames to obtain transform coefficients;
an inverse spatial transform unit for performing inverse spatial transform; and
an inverse temporal transform unit for performing inverse temporal transform using a reference frame including a virtual frame,
wherein the frames are restored by performing the inverse spatial and temporal transforms of the transform coefficients in inverse order to an order of redundancy removal.

25. The video decoder as claimed in claim 24, wherein the inverse spatial transform unit performs the inverse spatial transform prior to the inverse temporal transform unit, and the inverse temporal transform unit performs the inverse temporal transform to frames subjected to the inverse spatial transform.

26. The video decoder as claimed in claim 25, wherein the inverse spatial transform unit performs the inverse spatial transform in an inverse wavelet transform mode.

27. The video decoder as claimed in claim 24, wherein the inverse temporal transform unit estimates the virtual frame using a weight which the bit-stream parsing unit parses the bit-stream to provide when a current frame in process of inverse temporal transform is temporally filtered in a coding procedure with the virtual frame set as the reference frame, and the inverse temporal transform unit performs the inverse temporal transform with the virtual frame set as the reference frame.

28. The video decoder as claimed in claim 27, wherein the virtual frame is estimated by the following formula:
$$p {\sum }_{k}^{} {S}_{n - 1} ( k ) + ( 1 - p ) {\sum }_{k}^{} {S}_{n + 1} ( k )$$
where p is the weight, Sₙ₋₁ and Sₙ₊₁ are the frames preceding and following the current frame in process of the inverse temporal transform by one step in time respectively, and k is the block which becomes a conversion target between the frames.

29. A video decoding method comprising:
receiving a bit-stream and parsing the received bit-stream to extract information on coded frames;
inversely quantizing the information on the coded frames to obtain transform coefficients; and
performing inverse spatial transform of the transform coefficients and inverse temporal transform by use of a reference frame including a virtual frame in inverse order to an order in which a redundancy of the coded frames is removed and restoring the coded frames.

30. The video decoding method as claimed in claim 29, wherein restoring the coded frames performs the inverse spatial transform to the transform coefficients, and performs the inverse temporal transform using the reference frame including the virtual frame.

31. The video decoding method as claimed in claim 30, wherein the inverse spatial transform is a wavelet transform mode.

32. The video decoding method as claimed in claim 29, wherein performing the inverse temporal transform estimates the virtual frame using a weight parsed from the received bit-stream when a current frame in process of the inverse temporal transform is temporally filtered in a coding procedure with the virtual frame set as the reference frame, and performs the inverse temporal transform with the virtual frame set as the reference frame.

33. The video decoding method as claimed in claim 32, wherein the virtual frame is estimated by the following formula:
$$p {\sum }_{k}^{} {S}_{n - 1} ( k ) + ( 1 - p ) {\sum }_{k}^{} {S}_{n + 1} ( k )$$
where p is the weight, Sₙ₋₁ and Sₙ₊₁ are the frames preceding and following the current frame in process of the inverse temporal transform by one step in time respectively, and k is the block which becomes a conversion target between the frames.

34. A recording medium for recording programs capable of being read by a computer for executing the video decoding method claimed in claim 29.
